(19) United States
(12) Patent Application Publication
(10) Pub. No.: US 2025/0304178 A1
(43) Pub. Date: Oct. 2, 2025

(54) ASSEMBLY TYPE VEHICLE

(71) Applicants: Hyundai Motor Company, Seoul (KR); Kia Corporation, Seoul (KR)

(72) Inventors: Seung Yeon LEE, Gwacheon-Si (KR); Yoo Kyung SHIN, Seoul (KR)

(73) Assignees: Hyundai Motor Company, Seoul (KR); Kia Corporation, Seoul (KR)

(21) Appl. No.: 18/825,827

(22) Filed: Sep. 5, 2024

(30) Foreign Application Priority Data
Apr. 2, 2024 (KR) 10-2024-0044719

(51) Int. Cl. B62D 25/02; B60R 13/08; B62D 27/06

(52) U.S. Cl. CPC B62D 25/02; B60R 13/08; B62D 27/06

(57) ABSTRACT

An assembly type vehicle is configured not only to simplify an assembly process by enabling assembly of each portion through a sliding assembly structure, but also to enable manufacture of a vehicle tailored to meet diverse needs of users through a modular structure, securing assembly performance and productivity of the vehicle.

### CROSS-REFERENCE TO RELATED APPLICATION

The present application claims priority to Korean Patent Application No. 10-2024-0044719, filed on Apr. 2, 2024, the entire contents of which is incorporated herein for all purposes by this reference.

### BACKGROUND OF THE PRESENT DISCLOSURE

### Field of the Present Disclosure

The present disclosure relates to an assembly type vehicle configured not only to simplify a manufacturing process of the vehicle, but also to secure assembly performance and productivity of the vehicle.

### Description of Related Art

Recently, an urban air mobility (UAM) vehicle, a purpose-built vehicle (PBV), and a mobility transfer base (Hub) have attracted the attention of customers as future autonomous vehicles, and research and development has been actively conducted on the autonomous vehicles. Accordingly, various presentations and techniques related to autonomous vehicles are introduced into the current vehicle market.

The PBV is an electric vehicle-based ground transportation means configured to be moved by electric wheels that freely move 360 degrees. PBVs are modularization-based vehicles each functioning as a simple means of transportation and provide various services optimized for each passenger who is travelling to his or her destination. Furthermore, PBVs may be variously designed depending on preferences and needs of each customer. For example, PBVs may serve as an urban shuttle bus and may also be used to generate a variety of spaces such as leisure spaces for restaurants, cafes, and hotels, and spaces for essential social facilities such as hospitals and pharmacies. To the present end, the interior of a vehicle body may be customized using products modularized in consideration of various purposes.

However, because many parts are required to form each vehicle body of a vehicle such as a purpose-built vehicle, a manufacturing process of the vehicle is complicated. That is, a mold needs to be provided to manufacture a vehicle body. Furthermore, there are many welding and assembly processes, and a manufacturing line needs to be established for each process.

Accordingly, because the manufacturing process of the vehicle is complicated, assembly efficiency deteriorates, and mass production is required.

Additionally, it is difficult to reflect preferences and needs of each customer in consideration of recent mobility trends, which may cause limitations in providing a vehicle tailored to meet diverse tastes of users.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an assembly type vehicle configured not only to simplify a manufacturing process of the vehicle, but also to enable manufacture of a vehicle tailored to meet preferences and needs of each user through a modular structure, securing assembly performance and productivity of the vehicle.

In accordance with the present disclosure, the above and other objects may be accomplished by the provision of an assembly type vehicle including an external plate, an internal plate slidably coupled on an internal surface of the external plate, an insulation material located between the external plate and the internal plate, the insulation material having a heat insulation property, and a reinforcement beam slidably coupled on an internal surface of the internal plate in the same direction as a direction of the internal plate to be coupled with the external plate.

The external plate may have bent portions respectively formed at a first end portion and a second end portion thereof, wherein the bent portions may be formed by bending the first end portion and the second end portion inwards, and the internal plate may have insertion portions respectively formed at a first end portion and a second end portion thereof, wherein the first end portion and the second end portion may be respectively inserted into and accommodated on the bent portions.

The external plate may be divided into plural pieces, and the respective external plates may be connected to each other via a connection bar, each of the external plates may have fixing portions respectively formed at a first end portion and a second end portion thereof, and the connection bar may have coupling portions respectively formed at a first end portion and a second end portion thereof, wherein each of the coupling portions may allow a corresponding one of the fixing portions to be slidably assembled therewith.

The fixing portion may be formed of a plurality of protrusions or grooves, and the coupling portion may be formed of a plurality of grooves or protrusions inserted into the fixing portion.

Each of the protrusions of the fixing portion or the coupling portion may include a polygonal or circular cross-sectional shape at an extending and protruding tip portion thereof, wherein the tip portion of the protrusion may be formed to include a larger cross-sectional area than a cross-sectional area of an extending portion of the protrusion, and each of the grooves of the fixing portion or the coupling portion may include a cross-sectional shape formed to match the cross-sectional shape of each of the protrusions.

The internal plate may include an assembly portion formed therein and provided for coupling the reinforcement beam to the internal plate, and one or more assembly portions may be formed to allow the reinforcement beams to be assembled at different positions through the assembly portions.

The assembly portion may include a plurality of insertion grooves, each of the insertion grooves extending in an coupling direction of the internal plate, and the reinforcement beam may include a support frame extending in a straight line and connection frames, each of the connection frames extending from the support frame to be inserted into a corresponding one of the insertion grooves.

The assembly portion may be formed of an odd number of the insertion grooves spaced apart from each other, and the reinforcement beam may extend in a state of being disposed to face the insertion groove disposed at a center portion of the support frame to allow each of the connection frames to be inserted into a corresponding one of the insertion grooves.

The connection frame may include a main connection portion and sub-connection portions, wherein the main connection portion may be inserted into the centrally disposed insertion groove, and each of the sub-connection portions may be inserted into a corresponding one of the insertion grooves spaced apart from each other and disposed on opposite sides of the central insertion groove, the main connection portion may include a circular or angular cross-section at an extending tip portion thereof, and the central insertion groove may be formed to match the shape of the tip portion of the main connection portion.

The sub-connection portions may respectively extend from opposite sides of the support frame, and each of the sub-connection portions may curvedly extend to be diagonally inserted into a corresponding one of the insertion grooves spaced apart from each other and respectively disposed on the opposite sides of the central insertion groove.

The insulation material may be formed of a foam including a porous structure.

The reinforcement beam may be slidably coupled with the internal plate in a horizontal direction, and the plural reinforcement beams may be spaced apart from each other in a vertical direction on the opposite internal plates.

The assembly type vehicle may further include an internal panel formed to partially or entirely cover the reinforcement beam, the internal panel being slidably coupled on the internal surface of the internal plate in the same direction as an coupling direction of the reinforcement beam.

The internal panel may be partially cut to form a foldable folding portion, wherein the folding portion may be folded toward the internal plate to be in contact with the internal plate or the reinforcement beam.

The internal plate may include an assembly groove formed to extend in the same direction as an coupling direction of the reinforcement beam, wherein the assembly groove may be coupled with a convenience provision portion including any one of a display, a storage device, a design device, a sound device, a sensor, and a safety device.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing an assembly type vehicle according to an exemplary embodiment of the present disclosure;

FIG. 2 is a diagram showing an external plate of the assembly type vehicle shown in FIG. 1;

FIG. 3 is a diagram showing an assembly state of an external plate and an internal plate in the assembly type vehicle shown in FIG. 1;

FIG. 4 is a diagram showing an assembly state of an insulation material located between the external plate and the internal plate in the assembly type vehicle shown in FIG. 1;

FIG. 5 is a diagram showing an assembly state of a reinforcement beam on the internal plate in the assembly type vehicle shown in FIG. 1;

FIG. 6 is a cross-sectional view of the assembly type vehicle shown in FIG. 1;

FIG. 7 is a diagram showing the external plate, the internal plate, and a connection bar in the assembly type vehicle shown in FIG. 1;

FIG. 8 is a detailed assembly diagram of the internal plate and the reinforcement beam in the assembly type vehicle shown in FIG. 1;

FIG. 9 is a diagram showing an internal panel in the assembly type vehicle shown in FIG. 1;

FIG. 10 is a diagram showing a folding portion of the internal panel shown in FIG. 9; and

FIG. 11 is a diagram showing an assembly state of a convenience provision portion in the assembly type vehicle shown in FIG. 1.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the present disclosure will be described in detail through exemplary embodiments thereof with reference to the accompanying drawings. Wherever possible, the same reference numbers will be used throughout the drawings to refer to the same or like portions, and redundant descriptions thereof will be omitted.

Hereinafter, the suffixes “module”, “unit”, and “part” for components used in the following description are merely provided for facilitation of preparing the present specification. Therefore, the suffixes themselves do not have significant meanings or roles.

In describing the exemplary embodiments included herein, when it is determined that a detailed description of publicly known techniques to which the present disclosure pertains may obscure the gist of the present disclosure, the detailed description will be omitted. Furthermore, it should be understood that the accompanying drawings are merely illustrated to easily describe the exemplary embodiments included in the present specification, and therefore, the technical idea included in the present specification is not limited by the accompanying drawings. Furthermore, it should be noted that the accompanying drawings include all modifications, equivalents, and substitutes that fall within the spirit and technical scope of the present disclosure.

Meanwhile, in an exemplary embodiment of the present disclosure, terms such as “first” and/or “second” may be used to describe various components, but the components are not limited by the terms. The terms are used only for distinguishing one component from other components.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

In the present specification, an expression in a singular form also includes the plural sense, unless clearly specified otherwise in context.

It should be understood that expressions such as “comprise” and “have” in the present specification are intended to designate the presence of indicated features, numbers, steps, operations, components, parts, or combinations thereof, but do not exclude the presence or addition of one or more features, numbers, steps, operations, components, parts, or combinations thereof.

Hereinafter, an assembly type vehicle according to an exemplary embodiment of the present disclosure will be described with reference to the appended drawings.

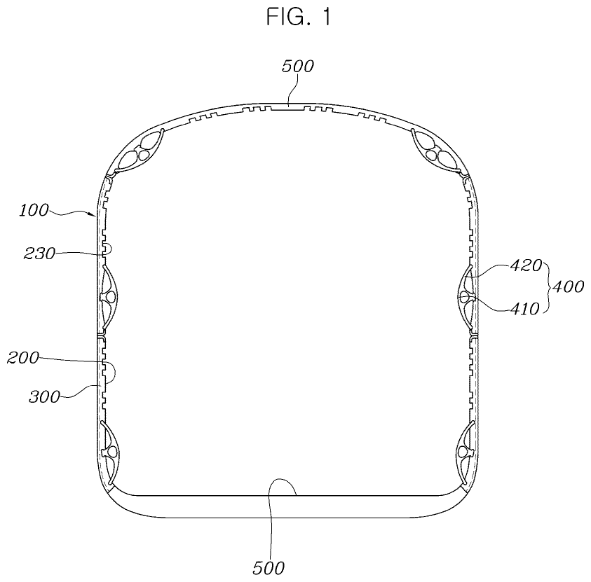

As shown in FIGS. 1 to 6, the assembly type vehicle according to an exemplary embodiment of the present disclosure includes an external plate 100, an internal plate 200 slidably assembled on the internal surface of the external plate 100, an insulation material 300 located between the external plate 100 and the internal plate 200, in which the insulation material 300 includes a heat insulation property, and a reinforcement beam 400 slidably assembled on the internal surface of the internal plate 200 in the same direction as a direction allowing the internal plate 200 to be assembled with the external plate 100.

The external plate 100 may be manufactured to match the external shape of the vehicle, and the internal plate 200 may also be manufactured to match the shape of the external plate 100.

The shape of the external plate 100 and the shape of the internal plate 200 may be determined through a process such as a roll forming process in consideration of a request from a user.

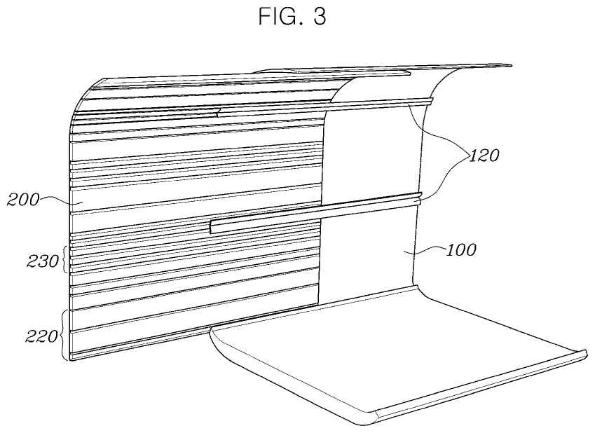

As shown in FIG. 3, the external plate 100 and the internal plate 200 are connected to each other by a sliding assembly method, simplifying an assembly process of the external plate 100 and the internal plate 200 and securing assembly efficiency. Furthermore, when the external plate 100 is assembled with the internal plate 200, additional processes such as screw fastening and welding may be minimized. Furthermore, the external plate 100 and the internal plate 200 may be easily assembled with each other and may be separated from each other using a sliding method, making it easy to manage and recycle the external plate 100 and the internal plate 200 from production to disposal.

The external plate 100 may have bent portions 110 respectively formed at one end portion and the other end portion thereof, in which the bent portions 110 are formed by bending the one end portion and the other end portion inwards, and the internal plate 200 may have insertion portions 210 respectively formed at one end portion and the other end portion thereof, in which the one end portion and the other end portion are respectively inserted into and accommodated on the bent portions 110.

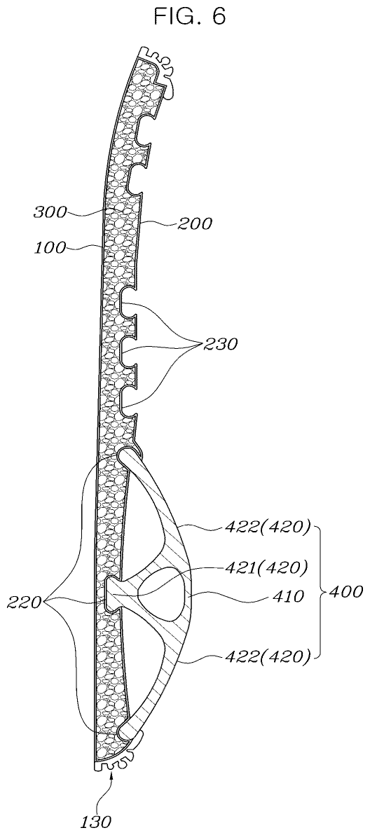

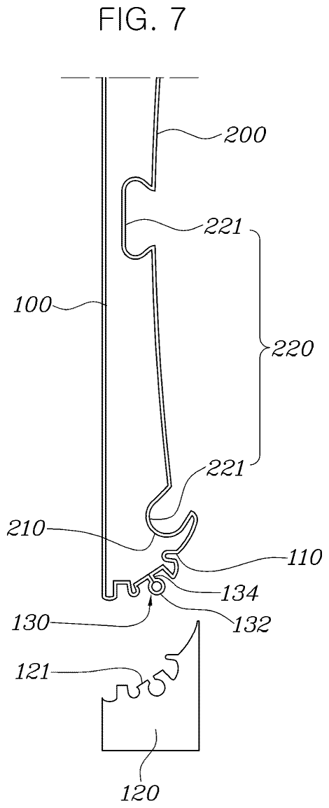

As shown in FIG. 6 and FIG. 7, the bent portion 110 is formed on the external plate 100 and the insertion portion 210 is formed on the internal plate 200. In the case of FIG. 7, the other end portion of each of the external plate 100 and the internal plate 200 is schematically shown. Here, one end portion thereof may be an upper side in the drawing, and the other end portion thereof may be a lower side in the drawing.

In the present manner, the bent portions 110 are respectively formed at one end portion and the other end portion of the external plate 100. Each of the bent portion 110 is bent in an inward direction toward the internal plate 200 to allow the internal plate 200 to enter the lower side of one end portion and the upper side of the other end portion.

The insertion portions 210 are respectively formed at one end portion and the other end portion of the internal plate 200. Here, the insertion portion 210 is formed to be accommodated on the internal side of the bent portion 110. Accordingly, the insertion portion 210 of the internal plate 200 may be formed to include a circular curve and may be formed to match the bent shape of the bent portion 110.

Through the present structural configuration, when the internal plate 200 is inserted into the bent portion 110 of the external plate 100, the insertion portion 210 slides in a state of being accommodated on the bent portion 110, and the external plate 100 and the internal plate 200 are assembled with each other in a sliding manner. Furthermore, the internal plate 200 is prevented from being separated inwards or outwards in a state of being slidably assembled with the external plate 100, maintaining a stable assembled state.

Meanwhile, in an exemplary embodiment of the present disclosure, as an external shape of a vehicle, the external plate 100 may be manufactured as a single piece. In another exemplary embodiment of the present disclosure, the external plate 100 may form a side portion of a vehicle, and upper and lower plates of the vehicle may be configured to be manufactured separately.

When the upper and lower plates are separately manufactured, the upper plate forming a roof portion and the lower plate forming a bottom portion are separated from each other, and the external plate 100 is assembled between the upper plate and the lower plate. In the case of the upper and lower plates, the external plate 100, the internal plate 200, the insulation material 300, and the reinforcement beam 400 described above may be configured in the same manner.

Meanwhile, the external plate 100 is divided into plural pieces, and the respective external plates 100 are connected to each other via a connection bar 120. Furthermore, each of the external plates 100 may have fixing portions 130 respectively formed at one end portion and the other end portion thereof, and the connection bar 120 may have coupling portions 121 respectively formed at one end portion and the other end portion thereof, in which each of the coupling portions 121 allows a corresponding one of the fixing portions 130 to be slidably assembled therewith.

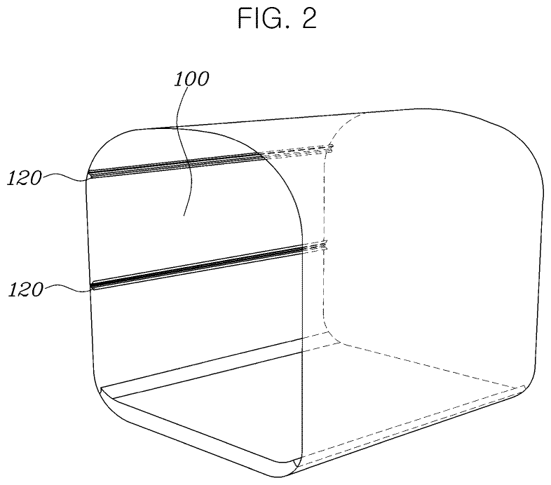

Referring to FIGS. 2 and 7, when the fixing portion 130 of the external plate 100 is assembled with the coupling portion 121 of the connection bar 120 in a sliding manner, an assembly process of the external plate 100 and the connection bar 120 is simplified, ensuring efficiency of the assembly process.

The fixing portions 130 may be respectively formed at the upper and lower end portions of the external plate 100, and the coupling portions 121 may be respectively formed at the upper and lower end portions of the connection bar 120.

Through the present structural configuration, the plural external plates 100 are connected to each other via the connection bar 120, and an overall size of the vehicle is adjustable depending on the number of connections of the external plate 100, making it possible to increase or decrease the size of an internal space.

Here, the fixing portion 130 of the external plate 100 may be formed of a plurality of protrusions or grooves, and the coupling portion 121 of the connection bar 120 may be formed of a plurality of grooves or protrusions inserted into the fixing portion 130.

As shown in FIG. 7, the fixing portion 130 is formed of a plurality of grooves, and the coupling portion 121 is formed of a plurality of protrusions.

In the present manner, because the fixing portion 130 is formed of grooves, the connection bar 120 may be moved in the sliding direction in a state in which the protrusions of the coupling portion 121 are inserted into the grooves of the fixing portion 130.

Each of the protrusions of the fixing portion 130 or the coupling portion 121 may include a polygonal or circular cross-sectional shape at an extending and protruding tip portion thereof. Here, the tip portion 132 of the protrusion may be formed to include a larger cross-sectional area than a cross-sectional area of an extending portion 134 of the protrusion, and each of the grooves of the fixing portion 130 or the coupling portion 121 may include a cross-sectional shape formed to match the cross-sectional shape of each of the protrusions.

Through the present structural configuration, in FIG. 7, the grooves of the fixing portion 130 and the protrusions of the coupling portion 121 may be assembled with each other in a sliding manner not in the upward-and-downward direction but in the forward-and-rearward direction looking at the drawing, i.e, in a longitudinal direction of the vehicle.

In the present manner, the tip portion 132 of the protrusion of the fixing portion 130 or the coupling portion 121 includes a larger cross-sectional area than that of the extending portion 134 of the protrusion, and the cross-sectional shape of the tip portion 132 is circular or polygonal. Accordingly, when the protrusion is inserted into the groove including the same shape, assembly may be performed only in a direction in which the protrusion is inserted into the groove, preventing the fixing portion 130 and the coupling portion 121 from being separated from each other in other directions.

Accordingly, the external plate 100 and the connection bar 120 may be assembled with each other in a sliding manner, and the fixing portion 130 and the coupling portion 121 are connected to each other through a plurality of grooves and protrusions. In the present manner, movement in the sliding direction is allowed, and movement in the other directions is restricted, making it possible to maintain a reliable coupling state.

As described above, in the vehicle according to an exemplary embodiment of the present disclosure, since the respective parts are assembled with each other in a sliding manner, assembly and management of the parts are easily performed.

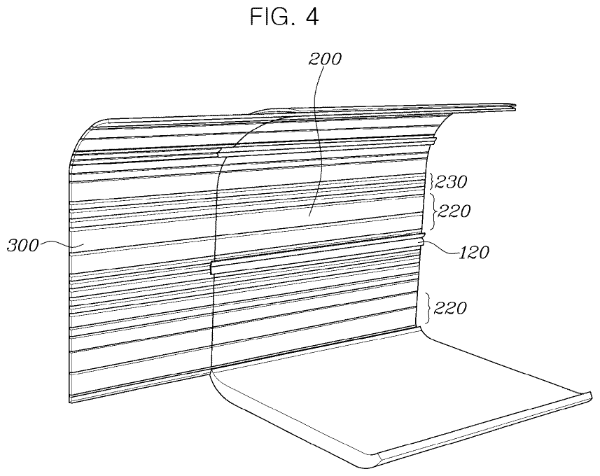

Meanwhile, as shown in FIG. 4, the insulation material 300 is located between the external plate 100 and the internal plate 200. The insulation material 300 may be formed of a foam including a porous structure.

In the present manner, the insulation material 300 is formed of a porous internal foam and is disposed between the external plate 100 and the internal plate 200, making it possible not only to prevent damage to the insulation material 300, but also to improve insulation performance through the insulation material 300.

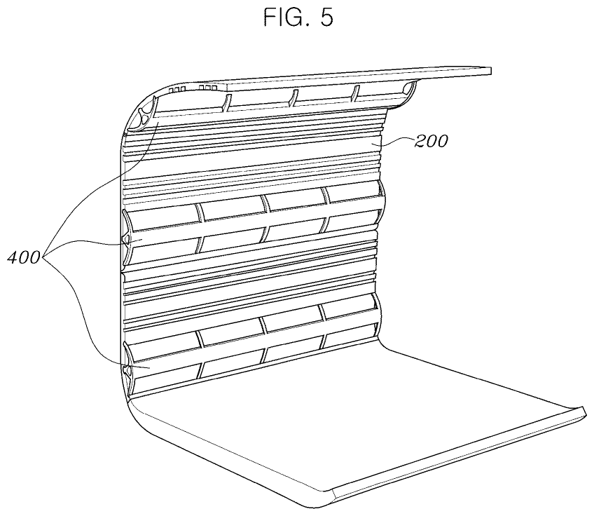

Meanwhile, as shown in FIG. 5, the reinforcement beam 400 is provided on the internal surface of the internal plate 200. Furthermore, the reinforcement beam 400 is slidably assembled with the internal plate 200 in the same direction as the direction in which the internal plate 200 is assembled with the external plate 100.

The reinforcement beam 400 may be formed of a rigid body and is assembled with the internal plate 200 to reinforce rigidity of the external plate 100 and the internal plate 200.

Furthermore, the reinforcement beam 400 is assembled with the internal plate 200 using a sliding method which is also used for assembly of the external plate 100 and the internal plate 200, securing assembly convenience of the reinforcement beam 400.

The internal plate 200 includes an assembly portion 220 formed therein and provided for coupling the reinforcement beam to the internal plate 400. One or more assembly portions 220 are formed to allow the reinforcement beams 400 to be assembled at different positions through the assembly portions 220.

In the present manner, the plurality of assembly portions 220 may be formed in the internal plate 200, and each of the reinforcement beams 400 may be selectively assembled with a corresponding one of the assembly portions 220. Installation locations of the reinforcement beams 400 and the number of reinforcement beams 400 may be determined depending on rigidity required for the external plate 100 and the internal plate 200.

For example, the reinforcement beam 400 is slidably assembled with the internal plate 200 in the horizontal direction thereof. Furthermore, the plurality of reinforcement beams 400 may be spaced apart from each other in the vertical direction on the opposite internal plates 200.

As shown in FIG. 5, the assembly portion 220 is formed to extend in the horizontal direction, which is the sliding assembly direction of the internal plate 200, and the reinforcement beam 400 assembled with the assembly portion 220 is assembled in the same direction as the internal plate 200, securing assembly convenience. Furthermore, because the plurality of assembly portions 220 are spaced apart from each other in the vertical direction on the internal plate 200, it is easy to secure the number of the reinforcement beams 400 to be provided and the installation locations of the reinforcement beams 400. Additionally, the formation position of the assembly portion 220 on the internal plate 200 may be determined through a collision test.

In detail, the assembly portion 220 may include a plurality of insertion grooves 221 each extending in the assembly direction of the internal plate 200. The reinforcement beam 400 may include a support frame 410 extending in a straight line and connection frames 420 each extending from the support frame 410 to be inserted into a corresponding one of the insertion grooves 221.

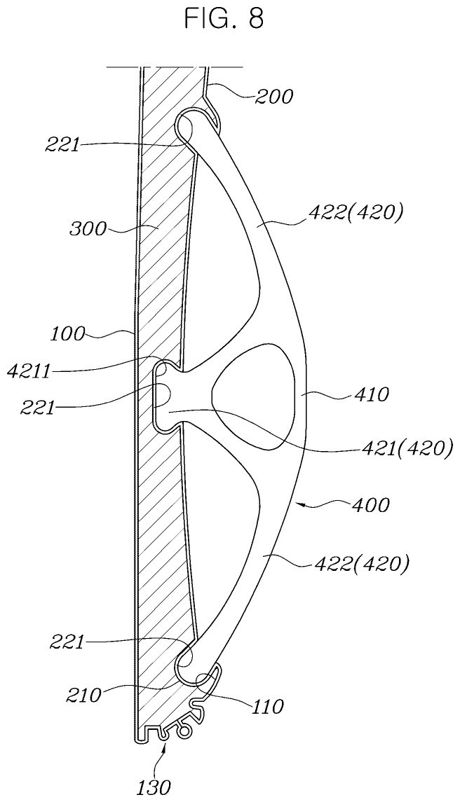

As shown in FIG. 6 and FIG. 8, the reinforcement beam 400 includes the support frame 410 and the connection frames 420. Here, the reinforcement beam 400 is assembled with the internal plate 200 by respectively inserting the connection frames 420 into the insertion grooves 221 of the assembly portion 220.

The support frame 410 forming the reinforcement beam 400 is formed as a hollow structure to secure rigidity thereof and reduce weight thereof.

The connection frame 420 extends from the support frame 410, and the insertion groove 221 of the assembly portion 220 is provided in plural. Accordingly, a plurality of connection frames 420 may be provided to be respectively connected to the insertion grooves 221. Furthermore, the connection frames 420 are spaced apart from each other at regular intervals in the longitudinal direction of the support frame 410. As a result, when the reinforcement beam 400 is assembled with the internal plate 200, the reinforcement beam 400 may be stably assembled with the assembly portion 220 of the internal plate 200 through a plurality of connection frames 420.

In an exemplary embodiment of the present disclosure, the assembly portion 220 may be formed of an odd number of the insertion grooves 221 spaced apart from each other, and the reinforcement beam 400 may extend in a state of being disposed to face the insertion groove 221 disposed at a center portion of the support frame 410 to allow each of the connection frames 420 to be inserted into a corresponding one of the insertion grooves 221.

In the description of the present disclosure, although three insertion grooves 221 are provided in the assembly portion 220, and three connection frames 420 are provided in the reinforcement beam 400, the number of insertion grooves 221 and connection frames 420 may be set in various ways.

As described above, three insertion grooves 221 may be provided, and the reinforcement beam 400 may include the connection frame 420 extending from the center portion of the support frame 410 and the other two connection frames 420 respectively extending from the opposite end portions of the support frame 410.

As shown in FIG. 8, the connection frame 420 may include a main connection portion 421 inserted into the centrally disposed insertion groove 221, and sub-connection portions 422 each inserted into a corresponding one of the insertion grooves 221 spaced apart from each other and disposed on opposite sides of the central insertion groove 221, in which the main connection portion 421 may include a circular or angular cross-sectional shape at an extending tip portion thereof.

The central insertion groove 221 may be formed to match the shape of the tip portion 4211 of the main connection portion 421.

In the present manner, the connection frames 420 in the reinforcement beam 400 include the main connection portion 421 and the sub-connection portions 422. The main connection portion 421 extends from a center portion of the support frame 410, and the sub-connection portions 422 extend in a radially spreading form from the opposite end portions of the support frame 410. Here, the main connection portion 421 may be formed to be thicker than the sub-connection portions 422.

Here, after the main connection portion 421 extends, a cross section of a tip portion 4211 of the main connection portion 421 includes a circular or angular shape. The insertion groove 221 matching the main connection portion 421 may be formed to include a circular or angular shape to match the tip portion shape of the main connection portion 421. In the present manner, the main connection portion 421 includes a circular or angular cross section at the tip portion 4211 thereof. As a result, when the main connection portion 421 is inserted into the insertion groove 221, movement of the main connection portion 421 is allowed only in the insertion direction, and movement of the main connection portion 421 in other directions is restricted, preventing the main connection portion 421 from being separated from the insertion groove 221.

Furthermore, the sub-connection portions 422 respectively extend from the opposite sides of the support frame 410. Furthermore, each of the sub-connection portions 422 curvedly extends to be inserted into a corresponding one of the insertion grooves 221 spaced apart from each other and respectively disposed on the opposite sides of the central insertion groove 221. In the present manner, each of the sub-connection portions 422 is diagonally inserted into a respective one of the insertion grooves 221.

That is, the sub-connection portions 422 radially extend from the support frame 410 and are diagonally inserted into the insertion grooves 221, respectively. Accordingly, tilting of the reinforcement beam 400 is restricted in the vertical direction in which the sub-connectors 422 respectively extend from the opposite sides of the support frame 410, and the reinforcement beam 400 is only permitted to move in a direction of being inserted into the insertion groove 221.

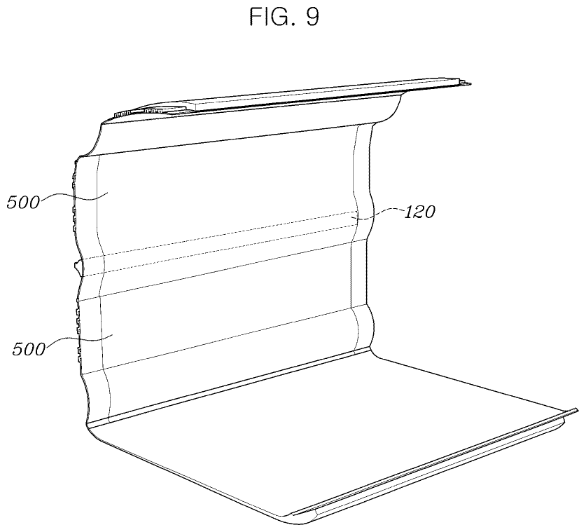

Meanwhile, as shown in FIG. 9, the assembly type vehicle according to an exemplary embodiment of the present disclosure may further include an internal panel 500 formed to partially or entirely cover the reinforcement beam 400 and slidably assembled on the internal surface of the internal plate 200 in the same direction as the assembly direction of the reinforcement beam 400.

The internal panel 500 may be manufactured depending on an internal design of a vehicle required by a user. Furthermore, the internal panel 500 may be formed to partially or entirely cover the reinforcement beam 400 and the internal surface of the internal plate 200, being exposed to the room from the internal surface of the internal plate 200.

Furthermore, the internal panel 500 is slidably assembled in the same direction as the assembly direction of the internal plate 200 and the reinforcement beam 400, making it possible to simplify an assembly process of the internal plate 200, the reinforcement beam 400, and the internal panel 500.

Meanwhile, the internal panel 500 is partially cut to form a foldable folding portion 510. The folding portion 510 may be folded toward the internal plate 200 and may contact with the internal plate 200 or the reinforcement beam 400.

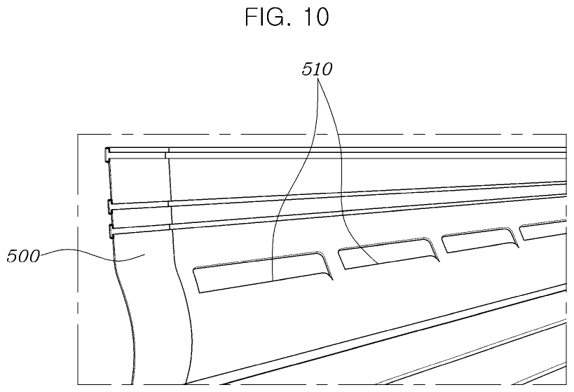

As shown in FIG. 10, the internal panel 500 includes the folding portion 510 formed thereon, and the folding portion 510 is cut from the internal panel 500 and then is folded toward the internal plate 200. Accordingly, a separate portion to connect the internal panel 500 to the internal plate 200 is not required. Because the folding portion 510 contacts with the internal plate 200 or the reinforcement beam 400 to form a support structure, the position of the internal panel 500 may be stably fixed.

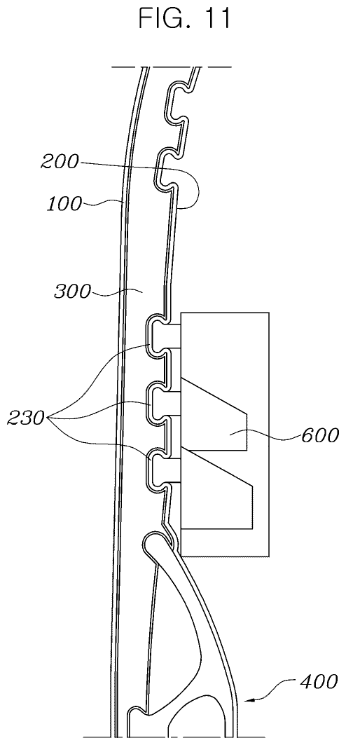

Meanwhile, as shown in FIG. 11, the internal plate 200 includes an assembly groove 230 formed to extend in the same direction as the assembly direction of the reinforcement beam 400. Here, the assembly groove 230 may be assembled with a convenience provision portion 600 including any one of a display, a storage device, a design device, a sound device, a sensor, and a safety device.

That is, the internal plate 200 may further include the assembly groove 230 formed therein in addition to the assembly portion 220 with which the reinforcement beam 400 is assembled. The convenience provision portion 600 is assembled in the assembly groove 230, providing convenience facilities such as an internal design device and a storage space depending on customer preferences.

The convenience provision portion 600 may be variously configured as an operating device, a bicycle stand, and the like, in addition to the above-described display, storage device, design device, sound device, sensor, and safety device.

In the present manner, various convenience provision portions 600 may be selectively assembled in the assembly groove 230 of the internal plate 200, and assembly is simplified, meeting various needs of users.

The assembly type vehicle including the above-described structure simplifies an assembly process by enabling assembly of each portion through a sliding assembly structure, and a modular structure makes it possible to manufacture the vehicle tailored to meet diverse needs of users, securing assembly performance and productivity of the vehicle.

As is apparent from the above description, the present disclosure provides an assembly type vehicle configured not only to simplify an assembly process by enabling assembly of each portion through a sliding assembly structure, but also to enable manufacture of a vehicle tailored to meet diverse needs of users through a modular structure, securing assembly performance and productivity of the vehicle.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An assembly type vehicle comprising:
an external plate;
an internal plate slidably coupled on an internal surface of the external plate;
an insulation material located between the external plate and the internal plate, the insulation material having a heat insulation property; and
a reinforcement beam slidably coupled on an internal surface of the internal plate in the same direction as a direction of the internal plate to be coupled with the external plate.

2. The assembly type vehicle of claim 1,
wherein the external plate includes bent portions respectively formed at a first end portion and a second end portion thereof, the bent portions formed by bending the first end portion and the second end portion inwards of the external plate, and
wherein the internal plate has insertion portions respectively formed at a first end portion and a second end portion of the internal plate, wherein the first end portion and the second end portion of the internal plate are respectively inserted into and accommodated on the bent portions of the external plate.

3. The assembly type vehicle of claim 1,
wherein the external plate is in plural, and the plurality of external plates are connected to each other via a connection bar,
wherein each of the external plates includes fixing portions respectively formed at a first end portion and a second end portion of each of the external plates, and
wherein the connection bar includes coupling portions respectively formed at a first end portion and a second end portion of the connection bar, wherein each of the coupling portions allows a corresponding one of the fixing portions to be slidably coupled therewith.

4. The assembly type vehicle of claim 3,
wherein each of the fixing portions includes a plurality of protrusions or grooves, and
wherein each of the coupling portions includes a plurality of grooves or protrusions inserted into the fixing portion.

5. The assembly type vehicle of claim 4,
wherein each of the protrusions of the fixing portions or the coupling portions includes a polygonal or circular cross-section at a tip portion thereof, wherein the tip portion of the protrusion is formed to include a larger cross-sectional area than a cross-sectional area of an extending portion of the protrusion, and
wherein each of the grooves of the fixing portions or the coupling portions includes a cross-section formed to match the cross-section of each of the protrusions.

6. The assembly type vehicle of claim 1,
wherein the internal plate includes an assembly portion formed in the internal plate and provided for coupling the reinforcement beam to the internal plate.

7. The assembly type vehicle of claim 6,
wherein the reinforcement beam is in plural, and
wherein the assembly portion is in plural and the plurality of assembly portions are formed to allow the reinforcement beams to be coupled at different positions through the plurality of assembly portions.

8. The assembly type vehicle of claim 6,
wherein the assembly portion includes a plurality of insertion grooves, each of the insertion grooves extending in an coupling direction of the internal plate, and
wherein the reinforcement beam includes a support frame extending in a straight line and connection frames, each of the connection frames extending from the support frame to be inserted into a corresponding one of the insertion grooves.

9. The assembly type vehicle of claim 8,
wherein the assembly portion includes an odd number of the insertion grooves spaced apart from each other, and
wherein the reinforcement beam extends in a state of being disposed to face a insertion groove disposed at a center portion of the support frame among the plurality of insertion grooves to allow each of the connection frames to be inserted into a corresponding one of remaining insertion grooves among the plurality of insertion grooves.

10. The assembly type vehicle of claim 8,
wherein the connection frames include a main connection portion and sub-connection portions, wherein the main connection portion is inserted into a centrally disposed insertion groove among the plurality of insertion grooves, and each of the sub-connection portions are inserted into a corresponding one of remaining insertion grooves spaced apart from each other and disposed on opposite sides of the central insertion groove among the plurality of insertion grooves,
wherein the main connection portion includes a circular or angular cross-section at a tip portion thereof, and
wherein the centrally disposed insertion groove is formed to match a shape of the tip portion of the main connection portion.

11. The assembly type vehicle of claim 10, wherein the sub-connection portions respectively extend from opposite sides of the support frame, and each of the sub-connection portions curvedly extends to be diagonally inserted into the corresponding one of the insertion grooves spaced apart from each other and respectively disposed on the opposite sides of the centrally disposed insertion groove.

12. The assembly type vehicle of claim 10, wherein the support frame forming the reinforcement beam includes a hollow to secure rigidity thereof and reduce weight thereof.

13. The assembly type vehicle of claim 1, wherein the insulation material is formed of a foam including a porous structure.

14. The assembly type vehicle of claim 1,
wherein the reinforcement beam is slidably coupled with the internal plate in a horizontal direction, and
wherein the reinforcement beam is in plural and the plurality of reinforcement beams are spaced apart from each other in a vertical direction on opposite internal plates.

15. The assembly type vehicle of claim 1, further including an internal panel formed to partially or entirely cover the reinforcement beam, the internal panel being slidably coupled on the internal surface of the internal plate in the same direction as an coupling direction of the reinforcement beam.

16. The assembly type vehicle of claim 15, wherein the internal panel is partially cut to form a foldable folding portion, wherein the folding portion is folded toward the internal plate to contact with the internal plate or the reinforcement beam.

17. The assembly type vehicle of claim 1,
wherein the internal plate includes an assembly groove formed to extend in the same direction as an coupling direction of the reinforcement beam so that the assembly groove is coupled with a convenience provision portion.

18. The assembly type vehicle of claim 17,
wherein the convenience provision portion includes any one of a display, a storage device, a design device, a sound device, a sensor, and a safety device.
